(19) United States
(12) Patent Application Publication
(10) Pub. No.: US 2026/0209598 A1
(43) Pub. Date: Jul. 23, 2026

(54) QUANTUM DOT-CONTAINING COMPOSITION, METHOD FOR PRODUCING THE SAME, AND WAVELENGTH CONVERSION MATERIAL

(71) Applicant: SHIN-ETSU CHEMICAL CO., LTD., Tokyo (JP)

(72) Inventors: Shinji AOKI, Annaka-shi (JP); Yoshihiro NOJIMA, Annaka-shi (JP); Kazuya NOJIMA, Annaka-shi (JP); Hitoshi MARUYAMA, Annaka-shi (JP)

(73) Assignee: SHIN-ETSU CHEMICAL CO., LTD., Tokyo (JP)

(21) Appl. No.: 19/138,797

(22) PCT Filed: Nov. 30, 2023
(86) PCT No.: PCT/JP2023/043016

§ 371 Date: Jun. 13, 2025

(30) Foreign Application Priority Data
Dec. 19, 2022 (JP) 2022-202453

(51) Int. Cl. C09K 11/88; B82Y 20/00; B82Y 40/00; C08K 9/06; C09K 11/02; C09K 11/08

(52) U.S. Cl. CPC C09K 11/883; C08K 9/06; C09K 11/025; C09K 11/0883; B82Y 20/00; B82Y 40/00; C08K 2201/011

(57) ABSTRACT

A quantum dot-containing composition, including quantum dots that emit fluorescence by excitation light, wherein the quantum dot-containing composition is a mixture of the quantum dots with a polymerizable polymer composition, the surfaces of the quantum dots include surface-covering layers having siloxane bonds, and the content of free thiol groups in the surface-covering layers is 4.0 mmol or less based on 1 g of the quantum dots. This provides a patternable quantum dot-containing composition that enables improving the stability of quantum dots while maintaining the characteristics thereof, and enables suppressing dark reactions such as thickening and the production of residues; a method for producing the composition; and a wavelength conversion material.

### TECHNICAL FIELD

The present invention relates to a quantum dot-containing composition, a method for producing the quantum dot-containing composition, and a wavelength conversion material.

### BACKGROUND ART

Single semiconducting nanocrystal particles with a crystal size equal to or less than the Bohr radius of exciton have a strong effect of confining quanta and discrete energy levels. The energy levels depend on the crystal size, which can be adjusted to regulate the light absorption wavelength or the emission wavelength. The effect of confining quanta enhances the efficiency of emission due to exciton recombination in single semiconducting nanocrystal particles, and the emission basically exhibits emission lines. Therefore, the achievement of the particle size distribution in which the single semiconducting nanocrystal particles are uniform in size enables high-brightness narrowband emission, which attracts attention. Such a phenomenon due to a strong effect of confining quanta in nanoparticles is referred to as the quantum size effect. Semiconducting nanocrystals using the properties thereof have been widely examined for the development of application thereof as quantum dots.

The utilization of quantum dots as phosphor material for displays has been examined as the application of the quantum dots. Since the achievement of narrowband high-efficiency emission enables the expression of colors that cannot be reproduced by conventional techniques, quantum dots have increasingly attracted attention as next-generation display materials.

Examples of displays in which the use of quantum dots have been advanced include quantum dot liquid crystal displays, which have already been commercialized. It has been attempted to pass white light or light radiated from blue LEDs through quantum dot-containing wavelength conversion materials, converting the color into green or red. Quantum dots have active surfaces, so that moisture or oxygen in the atmosphere gradually reduces the quantum yield. Improvement in the stability of quantum dot-containing wavelength conversion materials has therefore been necessarily examined.

The stabilization of quantum dot-containing wavelength conversion materials has been extensively examined. Examples include gas barrier sealing. The stability is improved by forming inner layers in which quantum dots are dispersed in an amphiphilic polymer or a compatible polymer and further dispersing the inner layers in another low gas-permeable resin layers. Patent Document 1 discloses a method comprising dispersing quantum dots (QDs) in a hydrophobic resin layer to form polymer beads; surface-modifying the polymer beads so as to disperse the polymer beads in a hydrophilic polymer; and dispersing the polymer beads in the hydrophilic polymer. Since hydrophilic polymers tend to be higher in gas barrier properties than hydrophobic polymers, QDs are dispersed in such two-layer or multilayer structure. Unfortunately, the gas barrier properties are insufficient for use in a high temperature and high humidity environment in which liquid crystal display units can be used, and a method is therefore adopted involving sandwiching a QD film between gas barrier films to prevent oxygen or steam from influencing the QD film.

Methods for manufacturing polymer beads have also been extensively examined. Patent Document 2 discloses a method involving manufacturing QD-containing polymer beads from polysiloxane having an amino group and a polymerizable functional group; further mixing a polymer having another polymerizable functional group therewith for emulsification; and further curing the emulsion. This method enables enhancing the adhesion with the QDs using the polymer into which ligands for coordinating with the surfaces of the QDs are introduced to increase the concentration of the QDs contained in the polymer beads for improving the stability. Unfortunately, even this method yields insufficient stability, so that sandwiching a QD film between barrier films yields practical applications.

The use of barrier films not only raises cost, but also inevitably increases the thickness. Nowadays, liquid crystal displays are required to be thinned, so that it is necessary to reduce the thicknesses of wavelength conversion materials. The stability therefore needs to be improved without barrier films. Since patterning is required in view of the application to color filters, the disposition of protective layers such as barrier films is not practical, so that quantum dots themselves need to be stable.

Patent Document 3 is disclosed as examination that has improved the heat resistance and the humidity resistance without using barrier films. This method involves further coating a multilayer resin composition having polymer bead structure of Patent Document 1, mentioned above, with silazane to improve the stability. Unfortunately, this method is disadvantageous in that the quantum yield is reduced upon the photocuring of silazane coating by the radiation of short ultraviolet rays (170 nm).

Patent Document 4 is disclosed as another attempt. This method involves coordinating ligands with quantum dots, introducing reactive substituents such as vinyl groups or methacrylic groups into the ligands, subsequently mixing silicone resin containing Si—H and a curing agent therewith, applying the mixture by spin coating, followed by heating and curing, resulting in the manufacturing of a film with improved heat resistance and humidity resistance. Unfortunately, the used silicone resin containing Si—H is less compatible with the quantum dots, so that it is attempted to disperse the quantum dots at high concentration, resulting in aggregation. Although the compatibility therefore has to be improved by ligand treatment, the quantum dots are likely to be aggregated, resulting in reduction in the quantum yield in the case where the coordination of the ligands changes the balance between the hydrophobic groups and the hydrophilic groups.

In the case of application to color filters, it is important to form a suitable surface state of quantum dots to the process for the patterning thereof. Nowadays, color filters are manufactured using photolithography involving applying a photosensitive resin composition containing a pigment to a glass substrate, drying the solvent, irradiating the coated substrate with UV for mask exposure, removing uncured portions by alkali development to form a pattern for a color, and repeating these steps to form patterns for blue, red, and green. Photolithography has many disadvantages such as a great loss of the raw materials due to waste of uncured portions, complicated steps, and the use of expensive equipment. Ink-jet styles have also therefore been examined recently. Ink-jet styles are competitive in terms of cost since the ink-jet styles involve no loss of raw materials, and enable manufacturing larger color filters or color filters having larger areas without the introduction of expensive equipment. Unfortunately, ink-jet styles are disadvantageous in that techniques for fabricating fine nozzles are difficult, and if nozzles are small, the nozzles clog up and eject inks unsteadily. Both photolithography, proven in terms of miniaturization, and ink-jet styles, which are competitive in terms of cost, have been examined.

Meanwhile, the preparation of resin compositions containing quantum dots highly dispersed at high concentration is difficult in both photolithography and ink jetting. The resin compositions except some resin compositions are dispersed in polar solvents such as PGMEA and PGME. Since quantum dots are basically hydrophobic and scarcely dispersed in these solvents or resin materials, leading to aggregation, it is difficult to prepare photosensitive resin compositions containing quantum dots highly dispersed at high concentration. Although the addition of dispersants has been examined as countermeasures, the addition is disadvantageous in that the addition reduces the contents of quantum dots or modifies the characteristics of the cured resins. While the compositions are commonly heated for volatilizing the solvents, at this time, the influence of impurities contained in quantum dots leads to dark reactions such as the insufficient curing, the thickening, and the production of residues.

### CITATION LIST

### Patent Literature

Patent Document 1: U.S. Pat. No. 9,708,532 B2
Patent Document 2: JP 2016-111292 A
Patent Document 3: JP 2019-536653 A
Patent Document 4: US20190322926 A1

### SUMMARY OF INVENTION

### Technical Problem

The present invention has been completed in view of the above-mentioned problem, and provides a patternable quantum dot-containing composition that enables improving the stability of quantum dots while maintaining the characteristics thereof, and enables suppressing dark reactions such as thickening and the production of residues; a method for producing the composition; and a wavelength conversion material.

### Solution to Problem

In order to achieve the above-mentioned object, the present invention provides:
a quantum dot-containing composition, comprising quantum dots that emit fluorescence by excitation light, wherein
the quantum dot-containing composition is a mixture of the quantum dots with a polymerizable polymer composition,
surfaces of the quantum dots comprise surface-covering layers having siloxane bonds, and
a content of free thiol groups in the surface-covering layers is 4.0 mmol or less based on 1 g of the quantum dots.

Such a quantum dot-containing composition is a patternable quantum dot-containing composition that enables improving the stability of quantum dots while maintaining the characteristics thereof, and enables suppressing dark reactions such as thickening and the production of residues.

It is preferable that the content of free thiol groups in the surface-covering layers be 3.0 mmol or less based on 1 g of the quantum dots.

Since such a quantum dot-containing composition is less likely to lead to insufficient curing, the composition is preferable.

It is preferable that the content of free thiol groups in the surface-covering layers be 1.0 mmol or less based on 1 g of the quantum dots.

Since such a quantum dot-containing composition enables further suppressing dark reaction, the composition is preferable.

It is preferable that the surface-covering layers have any one or more reactive substituents selected from a vinyl group, an acrylic group, a methacrylic group, a hydroxy group, a phenolic hydroxy group, and an epoxy group.

Since such reactive substituents prevent the aggregation of the quantum dots, the reactive substituents are preferable.

It is preferable that the polymerizable polymer composition comprise a polymerizable polymer having any one or more polymerizable substituents selected from a vinyl group, an acrylic group, a methacrylic group, a hydroxy group, a phenolic hydroxy group, and an epoxy group.

Such polymerizable substituents can be suitably used as a polymerizable substituent.

### The Present Invention Provides:

a wavelength conversion material that is a cured product of the above-mentioned quantum dot-containing composition.

Such a wavelength conversion material is a patternable wavelength conversion material that enables improving the stability of quantum dots while maintaining the characteristics thereof, and enables suppressing dark reactions such as thickening and the production of residues.

### The Present Invention Provides:

a method for producing the above-described quantum dot-containing composition comprising quantum dots that emit fluorescence by excitation light, comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that a content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.

Such a method for producing the quantum dot-containing composition enables producing a patternable quantum dot-containing composition that enables improving the stability of quantum dots while maintaining the characteristics thereof, and enables suppressing dark reactions such as thickening and the production of residues.

### Advantageous Effects of Invention

The object as described above has been earnestly examined repeatedly, so that it has been found that the formation of the surface-covering layers containing siloxane leads to the inactivation to improve the stability. In order to suppress dark reactions with the polymerizable polymer composition, the content of free thiol groups is furthermore reduced, which enables preparing a quantum dot-containing composition that can be cured without insufficient curing or the production of residues even though the quantum dots are added at high concentration. Consequently, this enables reducing the rate of decrease in internal quantum efficiency after the treatment for 250 hours in a reliability test at 85° C. and 85% RH without barrier films to 10% or less, resulting in the stabilization. This also enables materializing a quantum dot-containing composition wherein the composition has excellent patterning properties and high curability, and the dark reactions with a polymerizable polymer composition is suppressed.

### DESCRIPTION OF EMBODIMENTS

As described above, desired have been the development of a patternable quantum dot-containing composition that enables improving the stability of quantum dots while maintaining the characteristics thereof, and enables suppressing dark reactions such as thickening and the production of residues; a method for producing the composition; and a wavelength conversion material.

The present inventors have earnestly and repeatedly examined the above-mentioned object and consequently found that the content of free thiol groups can be reduced to 4.0 mmol or less based on 1 g of quantum dots for achieving the above-mentioned object, and completed the present invention.

That is, the present invention is a quantum dot-containing composition, comprising quantum dots that emit fluorescence by excitation light, wherein
the quantum dot-containing composition is a mixture of the quantum dots with a polymerizable polymer composition,
the surfaces of the quantum dots comprise surface-covering layers having siloxane bonds, and
the content of free thiol groups in the surface-covering layers is 4.0 mmol or less based on 1 g of the quantum dots.

Although the present invention will be described in detail hereinafter, the present invention is not limited thereto.

### (Quantum Dot-Containing Composition)

The quantum dot-containing composition of the present invention is a quantum dot-containing composition, comprising quantum dots that emit fluorescence by excitation light, wherein the quantum dot-containing composition is a mixture of the quantum dots with a polymerizable polymer composition, the surfaces of the quantum dots comprise surface-covering layers having siloxane bonds, and the content of free thiol groups in the surface-covering layers is 4.0 mmol or less based on 1 g of the quantum dots. That is, the quantum dot-containing composition of the present invention is a mixture thereof with the composite particles into which the surface-covering layers are formed on the surfaces of the quantum dots, and substituents to be polycondensed with the polymerizable polymer composition or polymerizable substituents are introduced into the skeletal structure substituent ligands of the polymerizable polymer composition.

### (Quantum Dots)

As long as the quantum dots in the present invention emit fluorescence by excitation light, the quantum dots may be any quantum dots, and can be used in any form. Although the quantum dots are mainly nanoparticles of 10 nm or less, for example, the quantum dots may be nanowires, nanorods, nanotubes, or nanocubes, and the quantum dots having any shape are applicable.

Any preferable material, for example, semiconducting material, is usable as the quantum dots for the present invention. Examples of the semiconducting material include semiconducting materials selected from the group consisting of II-VI semiconducting materials, III-V semiconducting materials, IV semiconducting materials, IV-VI semiconducting materials, I-III-VI semiconducting materials, II-IV-V semiconducting materials, mixed crystals or alloys thereof, and compounds having perovskite structures.

Specific examples include, but not limited to, ZnS, ZnSe, ZnTe, CdS, CdSe, CdTe, AlN, AlP, AlAs, AlSb, GaN, GaP, GaAs, GaSb, InN, InP, InAs, InSb, Si, Ge, Sn, Pb, PbS, PbSe, PbTe, SnS, SnSe, SnTe, AgGaS₂, AgInS₂, AgGaSe₂, AgInSe₂, CuGaS₂, CuGaSe₂, CuInS₂, CuInSe₂, ZnSiP₂, ZnGeP₂, CdSiP₂, CdGeP₂, CsPbCl₃, CsPbBr₃, CsPbI₃, CsSnCl₃, CsSnBr₃, and CsSnI₃.

The quantum dots used for the present invention can have core-shell structure. The shell material that can form the core-shell structure is not particularly limited, but preferably the shell material having a wide band gap between the shell material and the core material and a low lattice mismatch. The shell material can be freely combined with the core material depending thereon. Specific examples of the shell material include ZnO, ZnS, ZnSe, ZnTe, CdS, CdSe, CdTe, AlN, AlP, AlAs, AlSb, GaN, GaP, GaAs, GaSb, InN, InP, InAs, InSb, BeS, BeSe, BeTe, MgS, MgSe, MgTe, PbS, PbSe, PbTe, SnS, SnSe, SnTe, CuF, CuCl, CuBr, and CuI. The above-mentioned materials may be selected alone or as mixed crystals of two or more thereof, but the shell material is not limited thereto.

Although the method for producing the quantum dots includes various methods such as the liquid phase method and the gas phase method, in the present invention, the production method is not particularly limited, but it is preferable from the viewpoint that the quantum dots exhibit high fluorescence emission efficiency to use semiconducting nanoparticles obtained by the hot soap method or hot injection, involving reacting precursor species in nonpolar solvent having a high boiling point at high temperature. It is desirable that organic ligands be coordinated with the surfaces to impart dispersibility in the nonpolar solvent and reduce surface defects.

It is preferable from the viewpoint of dispersibility that the ligands contain aliphatic hydrocarbon. Examples of such ligands include oleic acid, stearic acid, palmitic acid, myristic acid, lauric acid, decanoic acid, octanoic acid, oleylamine, stearyl(octadecyl)amine, dodecyl(lauryl)amine, decyl amine, octylamine, octadecanethiol, hexadecanethiol, tetradecanethiol, dodecanethiol, decanethiol, octanethiol, trioctylphosphine, trioctylphosphine oxide, triphenylphosphine, triphenylphosphine oxide, tributylphosphine, and tributylphosphine oxide. These may be used alone, or two or more thereof may be combined.

(Ligands Having Substituents to be Coordinated with Quantum Dots)

It is desirable that ligands having substituents for forming siloxane bonds besides the above-mentioned ligands be coordinated with the quantum dots contained in the quantum dot-containing composition of the present invention. It is desirable that the ligands having substituents for forming siloxane bonds have substituents that interact with or adsorb on the surfaces of the quantum dots. Examples of the substituents adsorbed on or reacted with the surfaces of the quantum dots include an amino group, a carboxy group, a mercapto group, a phosphine group, a phosphine oxide group, a sulfonyl group, and a quaternary ammonium salt. Among these, an amino group, a carboxy group, a mercapto group, a phosphine group, and a quaternary ammonium salt are preferable from the viewpoint of the strength of coordinating properties.

Examples of the substituents for forming siloxane bonds include compounds containing alkoxysilanes such as a trimethoxysilyl group, a triethoxysilyl group, a dimethoxymethylsilyl group, a diethoxymethylsilyl group, a dimethylmethoxysilyl group, and an ethoxydimethylsilyl group; compounds having silazane bonds; compounds having Si—OH bonds; compounds having Si—X bonds (X: halogen); and carboxylic acids. Since the reaction can be progressed under mild conditions without the production of acid as a byproduct of the reaction, it is preferable to use alkoxysilane, silazane, or a ligand containing Si—OH.

### (Surface-Covering Layer)

The quantum dot-containing composition of the present invention contains the surface-covering layers having siloxane bonds on the surfaces of the quantum dots. It is desirable that the surfaces of the quantum dots be covered with polysiloxane at this time. It is therefore desirable to perform reaction with the substituents for forming siloxane bonds contained in the above-mentioned ligands having the substituents that coordinate with the quantum dots to form the quantum dot surface-covering layers containing polysiloxane.

It is desirable that the surface-covering layers on the surfaces of the quantum dots contained in the quantum dot-containing composition of the present invention have at least one or more substituents (reactive substituents) to be polymerized with the polymerizable polymer contained in the polymerizable polymer composition described below. It is desirable that the substituents to be polymerized with the polymerizable polymer form covalent bonds with the surface-covering layers and be contained therein. It is because the reactive substituents are less likely to be removed during the subsequent purification operation than if the reactive substituents form aggregates with the surface-covered quantum dots or if the reactive substituents are contained so as to coordinate with the surfaces of the quantum dots or the surface-covering layers.

Examples of the substituents to be polymerized with the polymerizable polymer include a vinyl group, an acrylic group, a methacrylic group, a hydroxy group, a phenolic hydroxy group, an epoxy group, a sulfonyl group, a carboxy group, and a thiol group. Preferable are any one or more reactive substituents selected from a vinyl group, an acrylic group, a methacrylic group, a hydroxy group, a phenolic hydroxy group, and an epoxy group since these reactive substituents are less likely to aggregate.

It has been revealed that if free thiol groups are present in the surface-covering layers at more than 4.0 mmol per 1 g of the quantum dots, the thiol groups are subjected to dark reaction with the above-mentioned reactive substituents, resulting in curing inhibition or the production of residues. The content of free thiol groups therefore needs to be 4.0 mmol or less per 1 g of the quantum dots, and is preferably 3.0 mmol or less, further preferably 1.0 mmol or less per 1 g of the quantum dots. Thiol is often used for synthesizing quantum dots and contained in most quantum dots as ligands. Although free thiol groups not coordinated with the surfaces of the quantum dots can be removed by purification, free thiol groups remain on the surfaces of the quantum dots, leading to dark reaction after insufficient purification. If the content of free thiol groups is 3.0 mmol or less per 1 g of the quantum dots, the curing is not inhibited, which is therefore preferable. As the content of free thiol groups decreases, the content becomes more preferable. Although the lower limit values is not particularly limited, but for example, the lower limit can be 0.05 mmol or more per 1 g of the quantum dots.

### (Polymerizable Polymer Composition)

The quantum dot-containing composition of the present invention is a mixture of the quantum dots with the polymerizable polymer composition. The polymerizable polymer composition contains the polymerizable polymer as the base polymer and a polymerization initiator, and may contain organic solvent, a polymerizable crosslinking agent, a photo-acid generator, an antioxidant, a light-scattering agent, and others in addition. Examples of a suitably usable polymerizable polymer include polymers derived from acrylic acid, methacrylic acid, acrylic ester, and methacrylic ester, respectively, and copolymers formed from combinations of two or more thereof; a polymer having glycidyl (meth)acrylate as a repeating unit; and polymers containing a siloxane skeleton, a urethane skeleton, a silphenylene skeleton, a norbornene skeleton, a fluorene skeleton, and an isocyanurate skeleton. Polymers to be used may be suitably selected depending on the purpose. Examples include acrylic resin; alkyd resin; melamine resin; epoxy resin; silicone resin; polyvinyl alcohol; polyvinyl pyrrolidone; polyamide; polyamide-imide; a polyimide precursor of polyimide and others and an esterified product thereof; and a reaction product of tetracarboxylic dianhydride and diamine. Polymerizable substituents are introduced into these polymerizable polymers, which can be used in combination with the polymerization initiator to be cured. Examples of radical polymerizable substituents include a vinyl group, an acrylic group, a methacrylic group, and a thiol group, and all thereof can be suitably used. Examples of cationic polymerizable substituents include a hydroxy group, a phenolic hydroxy group, an epoxy group, a glycidyl group, an oxetanyl group, and an isocyanate group, and all thereof can be suitably used. In order to imparting alkali developability, carboxy groups may be additionally introduced. It is preferable that the polymerizable polymer have any one or more polymerizable substituents selected from a vinyl group, an acrylic group, a methacrylic group, a hydroxy group, a phenolic hydroxy group, and an epoxy group among these.

It is also preferable that the quantum dot-containing composition of the present invention contain the polymerization initiator. Polymerization initiators include thermal polymerization initiators and photopolymerization initiators. Both can be suitably used depending on the base polymer. Examples of the radical photopolymerization initiator include Irgacure 290, Irgacure 651, Irgacure 754, Irgacure 184, Irgacure 2959, Irgacure 907, Irgacure 369, Irgacure 379, Irgacure 819, and Irgacure 1173 of the Irgacure® series, which is commercially available from BASF SE. Examples include TPO and Darocure 1173 of the Darocure® series. In addition, a well-known thermal radical polymerization initiator or a cationic photopolymerization initiator may be contained.

The content of the polymerization initiator is preferably 0.1 to 10 parts by mass, further preferably 0.2 to 5 parts by mass based on 100 parts by mass of the polymerizable polymer to be added.

The quantum dot-containing composition of the present invention may contain solvent for improving the coatability thereof. The solvent is suitably organic solvent from the viewpoint of the compatibility with the quantum dots, and examples include ketone, alkylene glycol ether, alcohol, and aromatic compounds. Examples of suitably usable solvent include ketones such as acetone, methyl ethyl ketone, and cyclohexanone; alkylene glycol ethers such as methyl Cellosolve (ethylene glycol monomethyl ether), butyl Cellosolve (ethylene glycol monobutyl ether), methyl Cellosolve acetate, ethyl Cellosolve acetate, butyl Cellosolve acetate, ethylene glycol monopropyl ether, ethylene glycol monohexyl ether, ethylene glycol dimethyl ether, diethylene glycol ethyl ether, diethylene glycol diethyl ether, propylene glycol monomethyl ether, propylene glycol monoethyl ether, propylene glycol monopropyl ether, propylene glycol monobutyl ether, propylene glycol monomethyl ether acetate, diethylene glycol methyl ether acetate, diethylene glycol ethyl ether acetate, diethylene glycol propyl ether acetate, diethylene glycol isopropyl ether acetate, diethylene glycol butyl ether acetate, diethylene glycol tertiary butyl ether acetate, triethylene glycol methyl ether acetate, triethylene glycol ethyl ether acetate, triethylene glycol propyl ether acetate, triethylene glycol isopropyl ether acetate, triethylene glycol butyl ether acetate, and triethylene glycol tertiary butyl ether acetate; alcohols such as methyl alcohol, ethyl alcohol, isopropyl alcohol, n-butyl alcohol, and 3-methyl-3-methoxybutanol; and aromatic compounds such as benzene, toluene, and xylene.

The quantum dot-containing composition in the present invention may additionally contain a polymerizable crosslinking agent, a photo-acid generator, an antioxidant, a light-scattering agent, and others without particular limitation. Preferable are the above that do not influence the coatability of the quantum dot-containing composition.

### (Method for Producing Quantum Dot-Containing Composition)

### The Present Invention Provides:

a method for producing the quantum dot-containing composition comprising quantum dots that emit fluorescence by excitation light and described above, comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that the content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.

The quantum dot-containing composition of the present invention can be produced, for example, by the following method.

The quantum dots with which the ligands containing long-chain hydrocarbon are coordinated are dispersed in a hydrophobic solvent to prepare a solution dispersing the quantum dots. The solution is mixed with ligands having the substituents for forming siloxane bonds and the substituents to be coordinated with the surfaces of the quantum dots for ligand exchange. The conditions for the ligand exchange reaction such as the added amounts, the heating temperature, the time, and the light irradiation are suitably changed depending on the types of the ligands.

The quantum dots with which the ligands having the substituents for forming siloxane bonds are coordinated are then reacted with the compound to be reacted with the substituents for forming siloxane bonds to form polysiloxane, resulting in the formation of the surface-covering layers containing siloxane bonds. Although the sol-gel method can be preferably used as a common method for forming polysiloxane bonds, the quantum dots are weak under acidic conditions or to moisture, and the sol-gel method is therefore preferably a sol-gel method under basic conditions, further preferably a non-hydrolytic sol-gel method using diphenylsilanediol or tetramethyldisiloxanediol. It is desirable that the surface-covering layers on the surfaces of the quantum dots contained in the quantum dot-containing composition of the present invention have at least one or more of the substituents (reactive substituents) to be polymerized with the polymerizable polymer contained in the polymerizable polymer composition described above or a skeletal structure with a similar structure. It is desirable that the compound having the substituents to be polymerized with the polymerizable polymer or the similar skeletal structure be contained in the surface-covering layers while forming covalent bonds. Examples of a suitably usable method for forming covalent bonds include, but not particularly limited to, a method involving introducing the substituents for forming siloxane bonds into the compound having the substituents to be polymerized with the polymerizable polymer or the similar skeletal structure, followed by the addition thereof before the non-hydrolytic sol-gel reaction, resulting in the incorporation thereof with covalent bonds formed into the surface-covering layers; and a method involving beforehand introducing the substituents to be polymerized with the polymerizable polymer contained in the polymerizable polymer composition before the above-described non-hydrolytic sol-gel reaction, followed by reacting the polymerizable polymer or monomers therewith, resulting in the introduction into the surface-covering layers.

After the formation of the surface-covering layers, unreacted materials are removed by purification, leading to the reduction of the content of free thiol groups contained in the surface-covering layers to 4.0 mmol or less based on 1 g of the quantum dots. The quantum dots covered with the surface-covering layers can then be mixed with the polymerizable polymer composition to produce the quantum dot-containing composition. The formation of the surface-covering layers enables improving the compatibility with the polymerizable polymer composition to produce the quantum dot-containing composition uniformly dispersing the quantum dots without aggregation.

In the present invention, the purification method is not particularly limited, but for example, ethanol is added for precipitation in the reaction solution, and the resultant is centrifuged, followed by removing the supernatant to enable purification.

In the present invention, the method for measuring the content of free thiol groups contained in the surface-covering layers may be any measuring method. For example, 1 g of DTNB (5,5′-dithiobis(2-nitrobenzoic acid)) is dissolved in 100 mL of EtOH. The solid concentration of a solution of the quantum dots in toluene is beforehand calculated from the difference between the weights before and after the removal of solvent of the solution. Then, 1 mL of the DTNB solution is added to 5 mL of the solution of the quantum dots in toluene, and the mixture is left to stand for one hour. The absorbance at 412 nm is measured with an ultraviolet-visible absorption spectrum measuring apparatus. The content of free thiol groups can be measured from the molar absorbance of the produced 2-nitro-5-mercaptobenzoic acid (ε=1.55×10⁴).

### (Wavelength Conversion Material)

A wavelength conversion material of the present invention is a cured product of the above-mentioned quantum dot-containing composition. Examples of the shape of the wavelength conversion material in the present invention include, but not particularly limited to, a wavelength conversion film wherein the quantum dot-containing composition is dispersed in the resin, and the quantum dot-containing composition is processed into a sheet shape and then cured to form the wavelength conversion material; and a wavelength conversion color filter patterned as an ink-jet or resist material. The wavelength conversion material may be manufactured by any method. For example, the quantum dot-containing composition can be applied to a transparent film or a substrate material of PET or polyimide, cured, and laminated to obtain a wavelength conversion material.

The composition can be applied to a transparent film using atomization such as spraying or ink jetting; spin coating; or a bar coater.

For example, a film coated with the quantum dot-containing composition can be heated at 60° C. for two hours and then heated at 150° C. for four hours to perform the method for curing the quantum dot-containing composition. The quantum dot-containing composition may be cured by photopolymerization reaction, and can be irradiated with light at a wavelength of 365 nm and an output of 4000 mW/cm² for 20 seconds using a UV-LED irradiator to be cured. These conditions are any conditions, and can be optionally changed depends on the purpose.

The substituents to be polymerized with the polymerizable polymer in the polymerizable polymer composition are introduced into such surface-covering layers to enable manufacturing a wavelength conversion material having high reliability after curing and formed without aggregation or curing inhibition.

### EXAMPLE

Although, hereinafter, the present invention will be further specifically described with reference to Examples and Comparative Examples, the present invention is not limited thereto. In the present Examples, a core-shell type quantum dots of InP/ZnSe/ZnS were used as quantum dot material.

### Example 1

### (Quantum Dot Core Synthesis Step)

First, 0.23 g (0.9 mmol) of palmitic acid, 0.088 g (0.3 mmol) of indium acetate, 10 mL of 1-octadecene were added to a flask. The mixture was heated and stirred at reduced pressure and 100° C. to be deaerated for one hour while the raw materials were dissolved. The flask was then purged with nitrogen.

Tris(trimethylsilyl)phosphine was mixed with trioctylphosphine to prepare a solution at a concentration of 0.2 M. Then, 0.75 mL (0.15 mmol) of the solution was added, and the temperature was raised to 300° C. The solution was colored from yellow to red, so that it was confirmed that core particles were produced.

### (Quantum Dot Shell Layer Synthesis Step)

Then, 2.85 g (4.5 mmol) of zinc stearate and 15 ml of 1-octadecene were added to another flask. The mixture was heated and stirred at reduced pressure and 100° C. to be deaerated for one hour while the zinc stearate was dissolved to provide 0.3 M solution of zinc stearate in octadecene. Subsequently, 3.0 mL (0.9 mmol) of this solution was added to the reaction solution after the synthesis of the cores, followed by cooling to 200° C. Then, 0.474 g (6.0 mmol) of selenium and 4 mL of trioctylphosphine were added to another flask. The mixture was heated at 150° C. for dissolution to prepare 1.5 M solution of selenium in trioctylphosphine. While the reaction solution beforehand cooled to 200° C. after the core synthesis step was heated to 320° C. for 30 minutes, the solution of selenium in trioctylphosphine was added in an amount of 0.1 mL at a time such that the total amount was 0.6 mL (0.9 mmol). The temperature of the mixture was held at 320° C. for ten minutes and then reduced to room temperature. Then, 0.44 g (2.2 mmol) of zinc acetate was add. The mixture was heated and stirred at reduced pressure and 100° C. for dissolution. The flask was purged with nitrogen again and heated to 230° C. Subsequently, 0.98 mL (4.0 mmol) of 1-dodecanethiol was added, and the temperature was held for one hour. The obtained solution was cooled to room temperature to prepare a core-shell type quantum dot-containing solution.

### (Ligand Exchange Step)

First, (3-mercaptopropyl)triethoxysilane (Tokyo Chemical Industry Co., Ltd.) was used as ligands having substituents for forming siloxane bonds and substituents to be coordinated with the surfaces of the quantum dots. Then, (3-mercaptopropyl)triethoxysilane (3.0 mmol) was added to the solution after the shell synthesis step cooled to room temperature as ligand exchange reaction. The mixture was stirred for 24 hours. After the end of the reaction, ethanol was added for precipitation in the reaction solution, followed by centrifugating the resultant to remove the supernatant. The same purification was repeated again, followed by dispersing the precipitate in toluene to prepare a solution of the quantum dots with which the ligands having the substituents for forming siloxane bonds were coordinated.

### (Surface-Covering Layer Formation Step and Purification Step)

Triethoxyvinylsilane (4.0 mmol), diphenylsilanediol (6.0 mmol), barium hydroxide monohydrate (0.15 mmol), and the solution of the quantum dots in toluene after the ligand exchange step were added to a flask beforehand purged with nitrogen. The mixture was heated and stirred at 65° C. for 24 hours. After the end of the reaction, the mixture was cooled to room temperature, followed by adding ethanol for precipitation in the reaction solution. The resultant was centrifuged to remove the supernatant. The precipitate was dispersed in toluene for purification.

### (Titration of Amount of Free Thiol)

In 100 mL of EtOH was dissolved 1 g of DTNB (5,5′-dithiobis(2-nitrobenzoic acid)). Then, the solid concentration was beforehand calculated from the difference between the weights of the solution of the quantum dots in toluene before and after the removal of the solvent. To 5 mL of the solution of the quantum dots in toluene was added 1 mL of the DTNB solution. The mixture was left to stand for one hour. Thereafter, the absorbance at 412 nm was measured with an ultraviolet-visible absorption spectrum measuring apparatus (available from JASCO Corporation, V-750). The amount of free thiol groups (amount of SH) was measured from the molar absorbance of the produced 2-nitro-5-mercaptobenzoic acid (ε=1.55×10⁴). The amount of the free SH contained in the quantum dots was calculated from the obtained molar mass of the free thiol groups and the above-described solid concentration of the quantum dots, so that the amount of the free SH was 1.01 mmol per 1 g of the quantum dots.

### (Polymerizable Polymer Composition Mixing Step)

The solution of the quantum dots dispersed in toluene after the surface-covering layer formation step and the methacrylate-modified silicone oil X-32-3817-3 (Shin-Etsu Chemical Co., Ltd.) were weighed and mixed at a nonvolatile component ratio such that the quantum dots were contained at 20% by mass. After the mixing, the solvent was removed with an evaporator to obtain a quantum dot-containing composition.

### (Step of Manufacturing Wavelength Conversion Material)

A wavelength conversion material was manufactured from the obtained quantum dot-containing composition. The quantum dot-containing composition was defoamed with an agitator/deaerator, poured onto a PET film, and formed into a thin film with a bar coater. The formed thin film was then irradiated with light at a wavelength of 365 nm and an output of 4000 mW/cm² in a nitrogen atmosphere using a UV-LED irradiator to photocure the quantum dot-containing layers, resulting in manufacturing of a wavelength conversion material of 50 μm.

### (Measurement of Emission Wavelength, Half-Value Width of Fluorescence Emission, and Fluorescence Emission Efficiency)

In Examples and Comparative Examples, the emission wavelength, the half-value width of the fluorescence emission, and the fluorescence emission efficiency (internal quantum efficiency) of the quantum dots at an excitation wavelength of 450 nm were measured with a quantum efficiency measuring system (QE-2100) available from Otsuka Electronics Co., Ltd. as the evaluation of fluorescence characteristics of the quantum dots.

### (Reliability Test)

The obtained wavelength conversion material was treated under conditions of 85° C. and 85% RH (relative humidity) for 250 hours and measured for fluorescence emission efficiency after the treatment to evaluate the reliability thereof.

### Comparative Example 1

The same procedure as in Example 1 was performed to the quantum dot shell layer synthesis step. The surface-covering layer formation step was performed without performing the step of adding ethanol for removing excess ligands after the ligand exchange to sediment the quantum dots for purification in the ligand exchange step. The amount of free SH was measured in the same way as in Example 1, so that the amount was 8 mmol per 1 g of the quantum dots. A wavelength conversion material was manufactured by the same method as in Example 1 except for the above. In the step of manufacturing the wavelength conversion material, the composition was thickened, and was not able to be defoamed or form a uniform film.

### Comparative Example 2

The same procedure as in Example 1 was performed to the quantum dot shell layer synthesis step.

### (Ligand Exchange Step)

First, (3-dimethylaminopropyl)triethoxysilane (Tokyo Chemical Industry Co., Ltd.) was used as ligands having substituents for forming siloxane bonds and substituents to be coordinated with the surfaces of the quantum dots. As ligand exchange reaction, (3-dimethylaminopropyl)triethoxysilane (3.0 mmol) was added to the solution after the shell synthesis step cooled to room temperature, and the mixture was stirred for 24 hours. After the end of the reaction, a solution of the quantum dots was prepared in the same way as in Comparative Example 1. The amount of free SH was measured in the same way as in Example 1 after the surface-covering layer formation step, so that the amount was 6 mmol per 1 g of the quantum dots. A wavelength conversion material was manufactured by the same method as in Example 1 except the above. In the step of manufacturing the wavelength conversion material, the composition was thickened, and was not able to be defoamed or form a uniform film.

### Example 2

The same procedure as in Example 1 was performed to the surface-covering layer formation step and the purification step to prepare a solution of the quantum dots.

### (Polymerizable Polymer Composition Mixing Step)

The solution of the quantum dots dispersed in toluene after the surface-covering layer formation step and the acrylic resin RA-4101 (Negami Chemical Industrial Co., Ltd) were weighed at a nonvolatile component ratio such that the quantum dots were contained at 20% by mass. Then, 5 parts by mass of Irgacure 1173 was added thereto and mixed therewith based on 100 parts by mass of the nonvolatile component of the acrylic resin. After the mixing, the solvent toluene was removed with an evaporator to obtain a quantum dot-containing composition.

### (Method for Manufacturing Wavelength Conversion Material)

A wavelength conversion material was manufactured from the obtained quantum dot-containing composition. The quantum dot-containing composition was vacuum-deaerated. The quantum dot-containing composition at solid concentration adjusted to 20% was poured into a metal mold coated with fluorine resin and having a rectangular shape with a size of 20 cm×10 cm and a thickness of 500 μm. The composition was heated on a hot plate at 120° C. for one hour to manufacture a quantum dot-containing layer while evaporating the solvent. The quantum dot-containing layer was partially cut out and developed with PGMEA solution for confirming no residual film. The remainder quantum dot-containing layer was irradiated with light at a wavelength of 365 nm and an output of 4000 mW/cm² for 20 seconds using a UV-LED irradiator in a nitrogen atmosphere for photocuring to manufacture a wavelength conversion material of 100 μm.

### Comparative Example 3

A wavelength conversion material was manufactured by the same method as in Example 2 except that the same method as in Comparative Example 1 was performed to the surface-covering layer formation step and the purification step. Since a residual film remained after the development with PGMEA solution, it was confirmed that the dark reaction was in progress. The remainder quantum dot-containing layer was irradiated with light at a wavelength of 365 nm and an output of 4000 mW/cm² for 20 seconds using a UV-LED irradiator for photocuring to manufacture a wavelength conversion material of 100 μm.

### Example 3

The same procedure as in Example 1 was performed to the ligand exchange step.

### (Surface-Covering Layer Formation Step and Purification Step)

Triethoxysilylpropyl methacrylate (4.0 mmol), diphenylsilanediol (6.0 mmol), barium hydroxide monohydrate (0.15 mmol), and the solution of the quantum dots in toluene after the ligand exchange step were added to a flask beforehand purged with nitrogen. The mixture was heated and stirred at 65° C. for 24 hours. After the end of the reaction, the mixture was cooled to room temperature, followed by adding ethanol for precipitation in the reaction solution. The resultant was centrifuged to remove the supernatant. The precipitate was dispersed in toluene. The prepared solution was added to a flask beforehand purged with nitrogen. To 100 parts by mass of the solution of the quantum dots in toluene was added 2 parts by mass of the isocyanuric acid derivative DA-MGIC (SHIKOKU KASEI HOLDINGS CORPORATION). One parts by mass of Irgacure 1173 was further added based on 100 parts by mass of DA-MGIC. The mixture was stirred, mixed, and then irradiated with light at a wavelength of 365 nm and an output of 4000 mW/cm² for 20 seconds using a UV-LED irradiator. After the end of the reaction, ethanol was added for precipitation. The resultant was centrifuged, followed by removal of the supernatant. The precipitate was dispersed in toluene again for purification. The amount of free SH was measured by the method way as in Example 1, so that the amount was 0.3 mmol per 1 g of the quantum dots.

### (Polymerizable Polymer Composition Mixing Step)

Epoxy-containing silicone resin (CAS No. 2253674-54-1, which was available from Shin-Etsu Chemical Co., Ltd.) and the solution of the quantum dots dispersed in toluene after the surface-covering layer formation step were weighed and mixed at a nonvolatile component ratio such that the quantum dots were contained at 20% by mass. Two parts by mass of the photo-acid generator CPI-310FG (available from San-Apro Ltd.) and 20 parts by mass of the crosslinking agent THI-DE were weighed and mixed based on 100 parts by mass of the nonvolatile component of the silicone resin. After the mixing, the solvent toluene was removed by distillation under reduced pressure to obtain a quantum dot-containing composition.

### (Method for Manufacturing Wavelength Conversion Material)

A wavelength conversion material was manufactured from the obtained quantum dot-containing composition. The quantum dot-containing composition was vacuum-deaerated. The quantum dot-containing composition at solid concentration adjusted to 20% was poured into a metal mold coated with fluorine resin and having a rectangular shape with a size of 20 cm×10 cm and a thickness of 500 μm. The composition was heated on a hot plate at 120° C. for one hour to manufacture a quantum dot-containing layer while evaporating the solvent. The quantum dot-containing layer was partially cut out and developed with PGMEA solution for confirming no residual film. The remainder quantum dot-containing layer was then irradiated with light at a wavelength of 365 nm and an output of 4000 mW/cm² for 20 seconds using a UV-LED irradiator in a nitrogen atmosphere for photocuring to manufacture a wavelength conversion material of 100 μm.

### Example 4

The same procedure to the ligand exchange step as in Example 1 was performed.

### (Surface-Covering Layer Formation Step and Purification Step)

Triethoxysilylpropyl methacrylate (4.0 mmol), diphenylsilanediol (6.0 mmol), barium hydroxide monohydrate (0.15 mmol), and the solution of the quantum dots in toluene after the ligand exchange step were added to a flask beforehand purged with nitrogen. The mixture was heated and stirred at 65° C. for 24 hours. After the end of the reaction, the mixture was cooled to room temperature, followed by adding ethanol for precipitation in the reaction solution. The resultant was centrifuged to remove the supernatant. The precipitate was dispersed in toluene. The mixture was centrifuged, followed by removal of the supernatant. The precipitate was dispersed in toluene. The mixture was added to a flask beforehand purged with nitrogen. Two parts by mass of the phenol-reactive compound BIOAP-FL (ASAHI YUKIZAI CORPORATION), having fluorene skeletons, was added to 100 parts by mass of the solution of the quantum dots in toluene. One part by mass of Irgacure 1173 was further added based on 100 parts by mass of BIOAP-FL. The mixture was stirred, mixed, and then irradiated with light at a wavelength of 365 nm and an output of 4000 mW/cm² for 20 seconds using a UV-LED irradiator. After the end of the reaction, ethanol was added for precipitation. The resultant was centrifuged, followed by removal of the supernatant. The precipitate was dispersed in toluene again for purification. The amount of free SH was measured by the same method as in Example 1, so that the amount was 0.2 mmol per 1 g of the quantum dots.

### (Polymerizable Polymer Composition Mixing Step)

Phenol-crosslinkable silicone resin (CAS No. 916059-41-1, which was available from Shin-Etsu Chemical Co., Ltd.) and the solution of the quantum dots dispersed in toluene after the surface-covering layer formation step were weighed and mixed at a nonvolatile component ratio such that the quantum dots were contained at 20% by mass. Two parts by mass of the photo-acid generator CPI-310FG (available from San-Apro Ltd.) and 20 parts by mass of the crosslinking agent THI-DE were weighed and mixed based on 100 parts by mass of the nonvolatile component of the silicone resin. After the mixing, the solvent toluene was removed by distillation under reduced pressure to obtain a quantum dot-containing composition.

### (Method for Manufacturing Wavelength Conversion Material)

A wavelength conversion material was manufactured from the obtained quantum dot-containing composition. The quantum dot-containing composition was deaerated. The quantum dot-containing composition at solid concentration adjusted to 20% was poured into a metal mold coated with fluorine resin and having a rectangular shape with a size of 20 cm×10 cm and a thickness of 500 μm. The composition was heated on a hot plate at 120° C. for one hour to manufacture a quantum dot-containing layer while evaporating the solvent. The quantum dot-containing layer was partially cut out and developed with PGMEA solution for confirming no residual film. The remainder quantum dot-containing layer was then irradiated with light at a wavelength of 365 nm and an output of 4000 mW/cm² for 20 seconds using a UV-LED irradiator in a nitrogen atmosphere for photocuring to manufacture a wavelength conversion material of 100 μm.

### Example 5

The same method as in Comparative Example 1 was performed to the ligand exchange step. Then, the same method as in Example 4 was performed to the polymerizable polymer composition mixing step. The amount of free SH was measured by the same method as in Example 1, so that the amount was 3.5 mmol per 1 g of the quantum dots.

### (Method for Manufacturing Wavelength Conversion Material)

A wavelength conversion material was manufactured from the obtained quantum dot-containing composition. The quantum dot-containing composition was vacuum-deaerated. The quantum dot-containing composition at solid concentration adjusted to 20% was poured into a metal mold coated with fluorine resin and having a rectangular shape with a size of 20 cm×10 cm and a thickness of 500 μm. The composition was heated on a hot plate at 120° C. for one hour to manufacture a quantum dot-containing layer while evaporating the solvent. The quantum dot-containing layer was partially cut out and developed with PGMEA solution for confirming no residual film. The remainder quantum dot-containing layer was then irradiated with light at a wavelength of 365 nm and an output of 4000 mW/cm² for 20 seconds using a UV-LED irradiator in a nitrogen atmosphere for photocuring to manufacture a wavelength conversion material of 100 μm. Consequently, some of the composition was confirmed as residual liquid, which showed that the curing was inhibited. The residual liquid components were wiped off with waste cloth to manufacture a wavelength conversion material.

### Comparative Example 4

The same method as in Comparative Example 1 was performed to the surface-covering layer formation step. Then, the same method as in Example 4 was performed to the polymerizable polymer composition mixing step. The amount of free SH was measured by the same method as in Example 1, so that the amount was 4.2 mmol per 1 g of the quantum dots.

### (Method for Manufacturing Wavelength Conversion Material)

A wavelength conversion material was manufactured from the obtained quantum dot-containing composition. The quantum dot-containing composition was vacuum-deaerated. The quantum dot-containing composition at solid concentration adjusted to 20% was poured into a metal mold coated with fluorine resin and having a rectangular shape with a size of 20 cm×10 cm and a thickness of 500 μm. The composition was heated on a hot plate at 120° C. for one hour to manufacture a quantum dot-containing layer while evaporating the solvent. The quantum dot-containing layer was partially cut out and developed with PGMEA solution for confirming a residual film, which confirmed that dark reactions were in progress. The remainder quantum dot-containing layer was then irradiated with light at a wavelength of 365 nm and an output of 4000 mW/cm² for 20 seconds using a UV-LED irradiator in a nitrogen atmosphere for photocuring to manufacture a wavelength conversion material of 100 μm.

Table 1 shows the results of comparison between Examples 1 to 5 and Comparative Examples 1 to 4.

| | | Example | Example | Example | Example | Example |
|---|---|---|---|---|---|---|
| | | 1 | 2 | 3 | 4 | 5 |
| After quantum | Wavelength (nm) | 536 | ← | ← | ← | ← |
| dot synthesis | Half-value width (nm) | 41 | ← | ← | ← | ← |
| | Internal quantum | 68 | ← | ← | ← | ← |
| | efficiency (%) | | | | | |
| After surface- | Wavelength (nm) | 536 | ← | 536 | 536 | 536 |
| covering layer | Half-value width (nm) | 41 | ← | 42 | 41 | 41 |
| formation | Internal quantum | 64 | ← | 62 | 63 | 67 |
| | efficiency (%) | | | | | |
| | Amount of free SH | 1.01 | ← | 0.3 | 0.2 | 3.5 |
| | (mmol/QD 1 g) | | | | | |
| Quantum dot- | Wavelength (nm) | 536 | 537 | 539 | 534 | 540 |
| containing | Half-value width (nm) | 41 | 42 | 41 | 42 | 49 |
| composition | Internal quantum | 62 | 64 | 59 | 62 | 58 |
| | efficiency (%) | | | | | |
| Wavelength | Wavelength (nm) | 536 | 538 | 539 | 534 | 544 |
| conversion | Half-value width (nm) | 41 | 42 | 42 | 42 | 51 |
| material | Internal quantum | 54 | 49 | 45 | 50 | 35 |
| | efficiency (%) | | | | | |
| Amount of free SH contained in quantum | | 1 | 1 | 0.3 | 0.2 | 3.5 |
| dot-containing composition (mmol/g) | | | | | | |
| Change in | Rate of decrease (%) | 3 | 5 | 10 | 8 | — |
| internal | | | | | | |
| quantum | | | | | | |
| efficiency | | | | | | |
| after | | | | | | |
| reliability | | | | | | |
| test | | | | | | |

| | | | | | |
|---|---|---|---|---|---|
| Presence or absence of thickening of quantum | Absent | Absent | Absent | Absent | Absent |
| dot-containing composition | | | | | |
| Presence or absence of residual film after | — | Absent | Absent | Absent | Absent |
| PGMEA treatment | | | | | |
| Presence or absence of insufficient | Absent | Absent | Absent | Absent | Present |
| photocuring | | | | | (curing |
| | | | | | inhibition) |

| | | Comparative | Comparative | Comparative | Comparative |
|---|---|---|---|---|---|
| | | Example 1 | Example 2 | Example 3 | Example 4 |
| After quantum | Wavelength (nm) | ← | ← | ← | ← |
| dot synthesis | Half-value width (nm) | ← | ← | ← | ← |
| | Internal quantum | ← | ← | ← | ← |
| | efficiency (%) | | | | |
| After surface- | Wavelength (nm) | 536 | 536 | 536 | 536 |
| covering layer | Half-value width (nm) | 41 | 41 | 41 | 41 |
| formation | Internal quantum | 68 | 64 | 66 | 67 |
| | efficiency (%) | | | | |
| | Amount of free SH | 8 | 6 | 8 | 4.2 |
| | (mmol/QD 1 g) | | | | |
| Quantum dot- | Wavelength (nm) | 539 | 540 | 539 | 540 |
| containing | Half-value width (nm) | 46 | 48 | 46 | 48 |
| composition | Internal quantum | 66 | 61 | 63 | 55 |
| | efficiency (%) | | | | |
| Wavelength | Wavelength (nm) | 536 | 544 | 542 | 544 |
| conversion | Half-value width (nm) | 48 | 49 | 52 | 51 |
| material | Internal quantum | 45 | 38 | 39 | 33 |
| | efficiency (%) | | | | |
| Amount of free SH contained in quantum | | 8 | 6 | 8 | 4.2 |
| dot-containing composition (mmol/g) | | | | | |
| Change in | Rate of decrease (%) | 4 | 10 | 15 | 12 |
| internal | | | | | |
| quantum | | | | | |
| efficiency | | | | | |
| after | | | | | |
| reliability | | | | | |
| test | | | | | |

| | | | | |
|---|---|---|---|---|
| Presence or absence of thickening of quantum | Present | Present | Absent | Absent |
| dot-containing composition | | | | |
| Presence or absence of residual film after | — | — | Present | Present |
| PGMEA treatment | | | | |
| Presence or absence of insufficient | Present | Present | Absent | Absent |
| photocuring | (foamed and | (foamed and | | |
| | nonuniform) | nonuniform) | | |

Table 1 shows the internal quantum efficiency after the curing of the quantum dot-containing composition (of the wavelength conversion material), the rate of decrease in internal quantum efficiency after the reliability evaluation, and the presence or absence of the thickening, the residual film, and the insufficient photocuring. The results in Table 1 show that the internal quantum efficiencies of Comparative Examples are lower than those of Examples, and the long-wavelength shifts of emission wavelengths of Comparative Examples are also larger than the long-wavelength shifts of emission wavelengths of Examples. Meanwhile, the comparison between the results of the reliability test (treatment at 85° C. and 85% RH for 250 hours) shows that although Comparative Examples greatly deteriorated as compared with Examples, the stabilities were comparatively satisfactory due to the formation of the surface-covering layers. The comparison between Example 1 and Comparative Examples 1 and 2 has shown that the quantum dot-containing compositions of Comparative Examples are further thickened, so that foam remains after the photocuring to deteriorate the film qualities. It has been observed that the other Comparative Examples are not thickened probably because the other Comparative Examples contain PGMEA as organic solvent. Meanwhile, the presence or absence of the residual films after the PGMEA treatment and the presence or absence of insufficient photocuring of Examples 2 to 5 and Comparative Examples 3 to 4 were compared, so that the residual films were not present in any of the Examples, and phenomena such as thickening did not occur in any of Examples, either. While Examples except Example 5 can be sufficiently cured to form the quantum dot-containing layers, in Comparative Examples 3 and 4, the residual films are formed after the PGMEA treatment, which has shown that the dark reaction with the thiol groups is in progress.

As mentioned above, it has been confirmed that the quantum dot-containing composition in the present invention exhibits high stability, exhibits a satisfactory film quality after the curing, and is applicable to a quantum dot-containing resist or a quantum dot-containing ink-jet ink.

The present description includes the following embodiments.
[1]: A quantum dot-containing composition, comprising quantum dots that emit fluorescence by excitation light, wherein
the quantum dot-containing composition is a mixture of the quantum dots with a polymerizable polymer composition,
surfaces of the quantum dots comprise surface-covering layers having siloxane bonds, and
a content of free thiol groups in the surface-covering layers is 4.0 mmol or less based on 1 g of the quantum dots.
[2]: The quantum dot-containing composition according to the above [1], wherein
the content of free thiol groups in the surface-covering layers is 3.0 mmol or less based on 1 g of the quantum dots.
[3]: The quantum dot-containing composition according to the above [2], wherein
the content of free thiol groups in the surface-covering layers is 1.0 mmol or less based on 1 g of the quantum dots.
[4]: The quantum dot-containing composition according to any one of the above [1] to [3], wherein
the surface-covering layers have any one or more reactive substituents selected from a vinyl group, an acrylic group, a methacrylic group, a hydroxy group, a phenolic hydroxy group, and an epoxy group.
[5]: The quantum dot-containing composition according to any one of the above [1] to [4], wherein
the polymerizable polymer composition comprises a polymerizable polymer having any one or more polymerizable substituents selected from a vinyl group, an acrylic group, a methacrylic group, a hydroxy group, a phenolic hydroxy group, and an epoxy group.
[6]: A wavelength conversion material that is a cured product of the quantum dot-containing composition according to any one of the above [1] to [5].
[7]: A method for producing the quantum dot-containing composition comprising quantum dots that emit fluorescence by excitation light according to any one of the above [1] to [5], comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that a content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.

The present invention is not limited to the above-mentioned embodiments. The above-mentioned embodiments are illustrative. The technical scope of the present invention includes any aspect that has substantially the same configuration and exhibits the same function and effect as in the technical idea described in Claims of the present invention.

1.-7. (canceled)

8. A quantum dot-containing composition, comprising quantum dots that emit fluorescence by excitation light, wherein
the quantum dot-containing composition is a mixture of the quantum dots with a polymerizable polymer composition,
surfaces of the quantum dots comprise surface-covering layers having siloxane bonds, and
a content of free thiol groups in the surface-covering layers is 4.0 mmol or less based on 1 g of the quantum dots.

9. The quantum dot-containing composition according to claim 8, wherein
the content of free thiol groups in the surface-covering layers is 3.0 mmol or less based on 1 g of the quantum dots.

10. The quantum dot-containing composition according to claim 9, wherein
the content of free thiol groups in the surface-covering layers is 1.0 mmol or less based on 1 g of the quantum dots.

11. The quantum dot-containing composition according to claim 8, wherein
the surface-covering layers have any one or more reactive substituents selected from a vinyl group, an acrylic group, a methacrylic group, a hydroxy group, a phenolic hydroxy group, and an epoxy group.

12. The quantum dot-containing composition according to claim 8, wherein
the polymerizable polymer composition comprises a polymerizable polymer having any one or more polymerizable substituents selected from a vinyl group, an acrylic group, a methacrylic group, a hydroxy group, a phenolic hydroxy group, and an epoxy group.

13. A wavelength conversion material that is a cured product of the quantum dot-containing composition according to claim 8.

14. A wavelength conversion material that is a cured product of the quantum dot-containing composition according to claim 9.

15. A wavelength conversion material that is a cured product of the quantum dot-containing composition according to claim 10.

16. A wavelength conversion material that is a cured product of the quantum dot-containing composition according to claim 11.

17. A wavelength conversion material that is a cured product of the quantum dot-containing composition according to claim 12.

18. A method for producing the quantum dot-containing composition comprising quantum dots that emit fluorescence by excitation light according to claim 8, comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that a content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.

19. A method for producing the quantum dot-containing composition comprising quantum dots that emit fluorescence by excitation light according to claim 9, comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that a content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.

20. A method for producing the quantum dot-containing composition comprising quantum dots that emit fluorescence by excitation light according to claim 10, comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that a content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.

21. A method for producing the quantum dot-containing composition comprising quantum dots that emit fluorescence by excitation light according to claim 11, comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that a content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.

22. A method for producing the quantum dot-containing composition comprising quantum dots that emit fluorescence by excitation light according to claim 12, comprising:
a ligand exchange step of mixing a solution dispersing the quantum dots with ligands having substituents for forming siloxane bonds to coordinate the ligands with the outermost surfaces of the quantum dots;
a surface-covering layer formation step of, after the ligand exchange step, reacting the substituents for forming siloxane bonds with a compound to be reacted with the substituents for forming siloxane bonds to produce polysiloxane, thereby forming the surface-covering layers;
a purification step of, after the surface-covering layer formation step, performing purification, so that a content of free thiol groups in the surface-covering layers is 4.0 mmol or less based on 1 g of the quantum dots; and
a polymerizable polymer composition mixing step of, after the purification step, mixing the quantum dots covered with the surface-covering layers with the polymerizable polymer composition.
